(19) United States
(12) Patent Application Publication
(10) Pub. No.: US 2025/0028154 A1
(43) Pub. Date: Jan. 23, 2025

(54) OPTICAL SYSTEM AND IMAGING APPARATUS INCLUDING THE SAME

(71) Applicant: CANON KABUSHIKI KAISHA, Tokyo (JP)

(72) Inventors: KENJI SHINOHARA, Tochigi (JP); YUKI MATSUBA, Tochigi (JP)

(21) Appl. No.: 18/773,266

(22) Filed: Jul. 15, 2024

(30) Foreign Application Priority Data
Jul. 20, 2023 (JP) 2023-118058

(51) Int. Cl. G02B 13/00; G02B 9/60; G02B 9/62

(52) U.S. Cl. CPC G02B 13/0045; G02B 9/60; G02B 9/62

(57) ABSTRACT

An optical system includes a first lens unit, a second lens unit having a negative refractive power, a third lens unit, and a fourth lens unit having a positive refractive power arranged in that order from an object side to an image side. Intervals between adjacent ones of the lens units change during focusing. The second lens unit moves toward the image side and the fourth lens unit moves toward the object side during focusing from infinity to close range. A certain inequality is satisfied.

### BACKGROUND OF THE INVENTION

### Field of the Invention

The present invention relates to an optical system, and is suitable for application to imaging apparatuses, such as a digital video camera, a digital still camera, a broadcast camera, and a silver-halide film camera.

### Description of the Related Art

In recent years, a small optical system capable of performing high-speed focusing is desired for use in an imaging apparatus.

Accordingly, methods for moving a plurality of lens units during focusing have been proposed to provide a small structure for reducing the variations in the aberrations during focusing while reducing the weights of the lens unit moved during focusing.

Japanese Patent Laid-Open No. 2022-140076 describes an optical system in which a second lens unit and a fourth lens move during focusing.

Japanese Patent Laid-Open No. 2022-140076 describes a structure including a first lens unit having a positive refractive power, a second lens unit having a negative refractive power, a third lens unit having a positive refractive power, a fourth lens unit having a positive refractive power, and a fifth lens unit having a negative refractive power arranged in that order from the object side to the image side. However, the second lens unit, which moves during focusing, has an excessively strong refractive power, and therefore causes an increase in so-called breathing, that is, variation in the angle of view during focusing.

### SUMMARY OF THE INVENTION

An optical system according to an aspect of the present invention includes a first lens unit, a second lens unit having a negative refractive power, a third lens unit, and a fourth lens unit having a positive refractive power arranged in that order from an object side to an image side. Intervals between adjacent ones of the lens units change during focusing. The second lens unit moves toward the image side and the fourth lens unit moves toward the object side during focusing from infinity to close range. The following inequality is satisfied:

$$- 10. < f 2 / f < - 3.6$$

where f2 is a focal length of the second lens unit and f is a focal length of an entire system.

Further features of the present invention will become apparent from the following description of exemplary embodiments with reference to the attached drawings.

### BRIEF DESCRIPTION OF THE DRAWINGS

FIG. 1 is a sectional view of lenses of an optical system according to a first embodiment when the optical system is focused at infinity.

FIGS. 2A and 2B show aberration diagrams of the optical system according to the first embodiment when the optical system is focused at infinity and close range, respectively.

FIG. 3 is a sectional view of lenses of an optical system according to a second embodiment when the optical system is focused at infinity.

FIGS. 4A and 4B show aberration diagrams of the optical system according to the second embodiment when the optical system is focused at infinity and close range, respectively.

FIG. 5 is a sectional view of lenses of an optical system according to a third embodiment when the optical system is focused at infinity.

FIGS. 6A and 6B show aberration diagrams of the optical system according to the third embodiment when the optical system is focused at infinity and close range, respectively.

FIG. 7 is a sectional view of lenses of an optical system according to a fourth embodiment when the optical system is focused at infinity.

FIGS. 8A and 8B show aberration diagrams of the optical system according to the fourth embodiment when the optical system is focused at infinity and close range, respectively.

FIG. 9 is a sectional view of lenses of an optical system according to a fifth embodiment when the optical system is focused at infinity.

FIGS. 10A and 10B show aberration diagrams of the optical system according to the fifth embodiment when the optical system is focused at infinity and close range, respectively.

FIG. 11 is a sectional view of lenses of an optical system according to a sixth embodiment when the optical system is focused at infinity.

FIGS. 12A and 12B show aberration diagrams of the optical system according to the sixth embodiment when the optical system is focused at infinity and close range, respectively.

FIG. 13 is a sectional view of lenses of an optical system according to a seventh embodiment when the optical system is focused at infinity.

FIGS. 14A and 14B show aberration diagrams of the optical system according to the seventh embodiment when the optical system is focused at infinity and close range, respectively.

FIG. 15 illustrates an arrangement including flare cut-off stops.

FIG. 16 is a schematic diagram illustrating an imaging apparatus.

### DESCRIPTION OF THE EMBODIMENTS

Optical systems according to embodiments of the present invention and imaging apparatuses including the optical systems will be described with reference to the accompanying drawings.

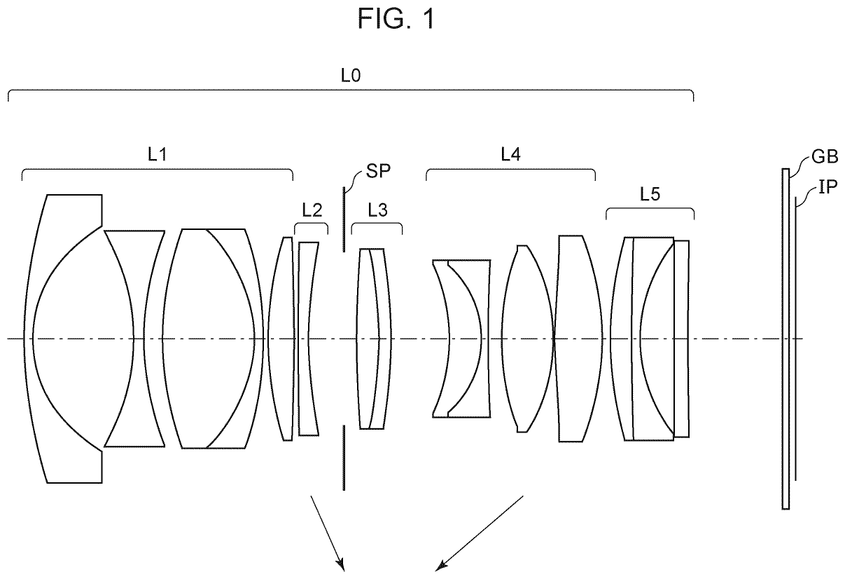

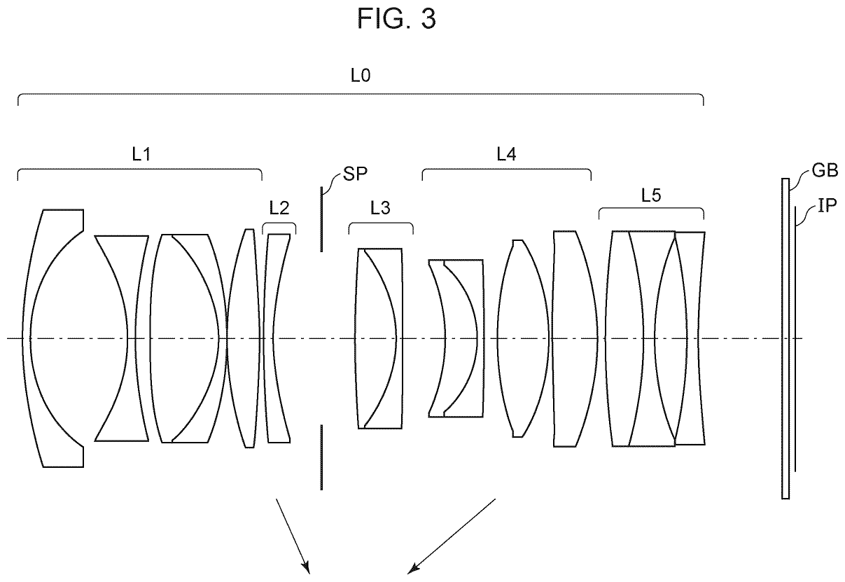

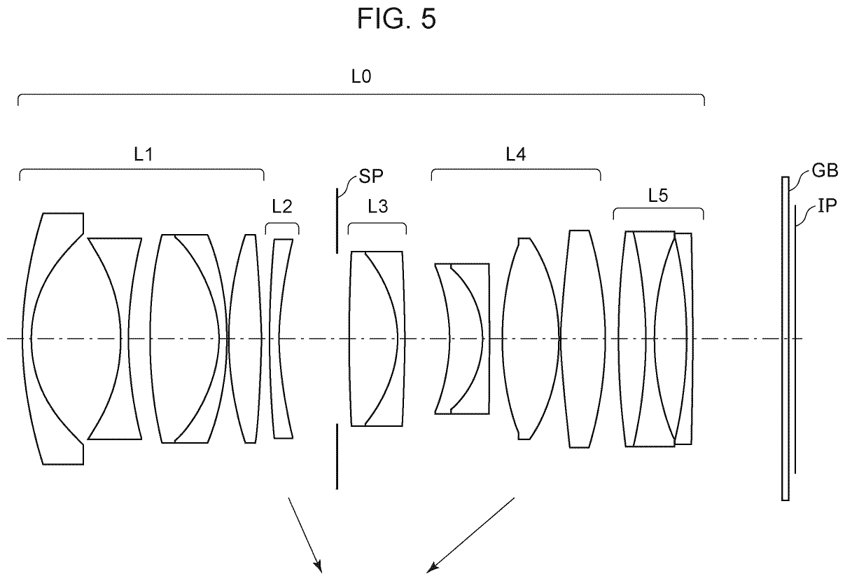

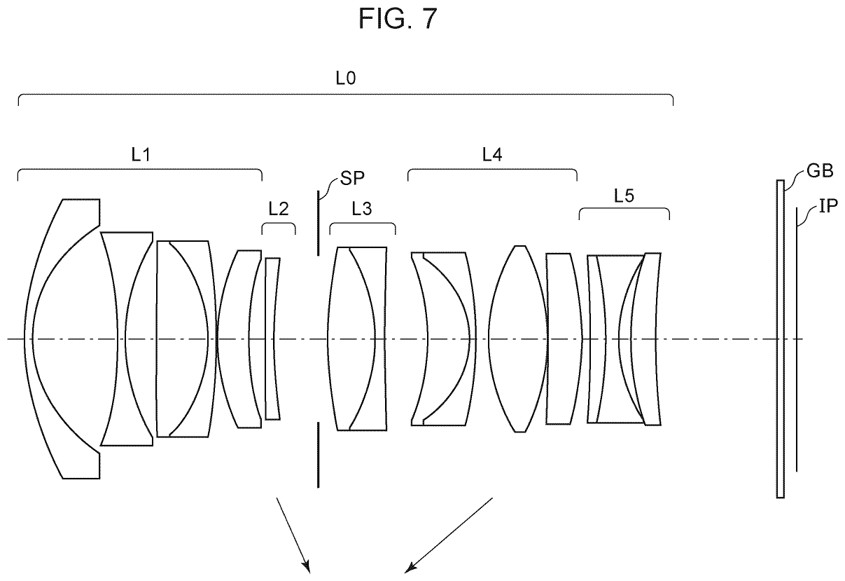

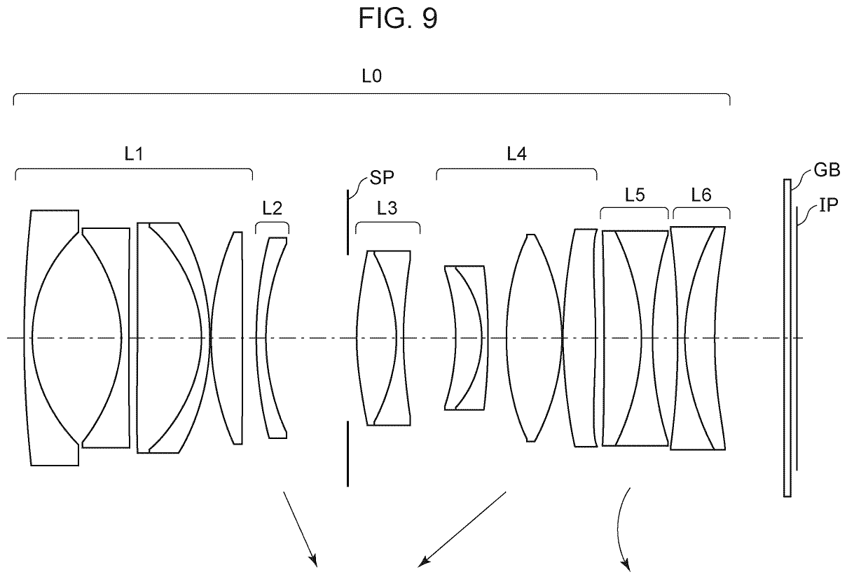

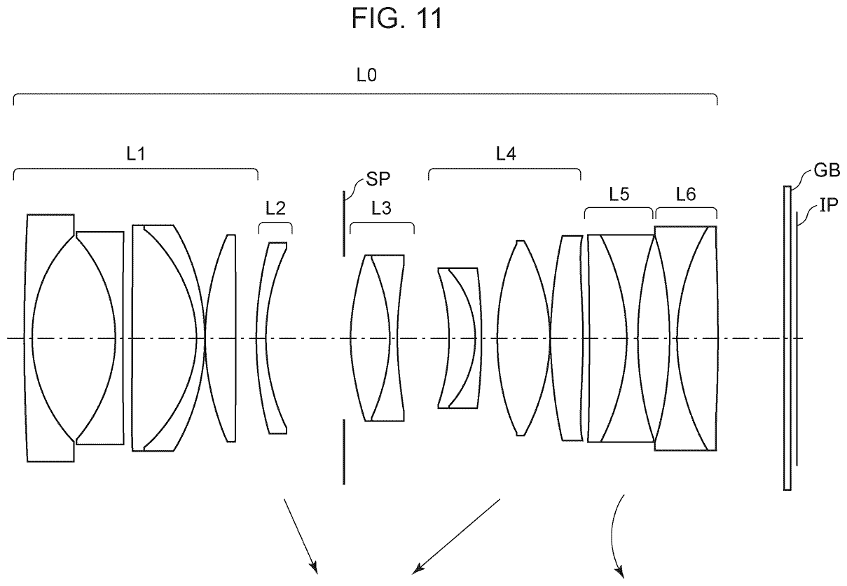

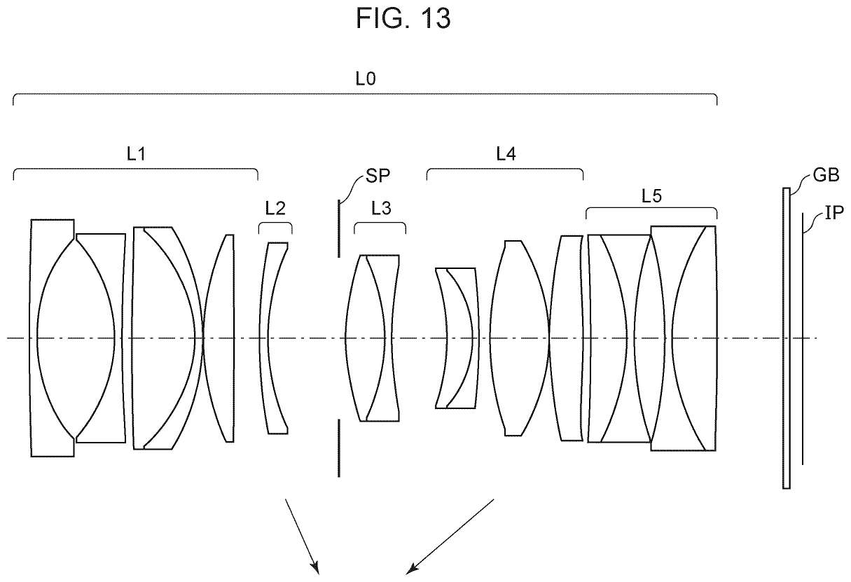

FIGS. 1, 3, 5, 7, 9, 11, and 13 are sectional views of optical systems L0 according to first to sixth embodiments when the optical system L0 is focused at infinity. The optical system L0 of each embodiment is an optical system included in an imaging apparatus, such as a digital video camera, a digital still camera, a broadcast camera, a silver-halide film camera, a monitoring camera, or an on-vehicle camera.

In each sectional view of the lenses, the left side is the object side and the right side is the image side. The optical system L0 of each embodiment may be used as a projection lens of a projector or the like. In such a case, a screen is on the left side and a projection image is on the right side.

The optical system L0 of each embodiment includes a first lens unit L1, a second lens unit L2 having a negative refractive power, a third lens unit L3, and a fourth lens unit LA having a positive refractive power arranged in that order from the object side to the image side. Intervals between adjacent ones of the lens units change during focusing. Each lens unit may be composed of a single lens or a plurality of lenses. The lens units may include an aperture stop.

In the sectional views of the lenses, the downward solid-line arrows show loci of movement of the lens units during focusing from infinity to close range.

In each sectional view of the lenses, SP denotes an aperture stop, and IP denotes an image plane. When the optical system L0 of each embodiment is included in a digital still camera or a digital video camera, an imaging plane of a solid-state imaging device (photoelectric transducer), such as a CCD sensor or a CMOS sensor, is disposed on the image plane IP. When the optical system L0 of each embodiment is used as an image-capturing optical system of a silver-halide film camera, a photosensitive surface, which corresponds to a film surface, is placed on the image plane IP.

GB denotes an optical block corresponding to, for example, an optical filter, a face plate, a crystal low-pass filter, or an infrared cut filter.

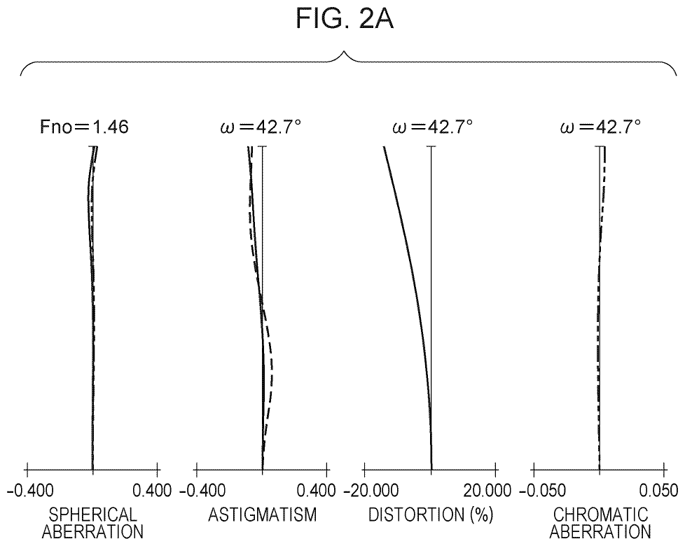

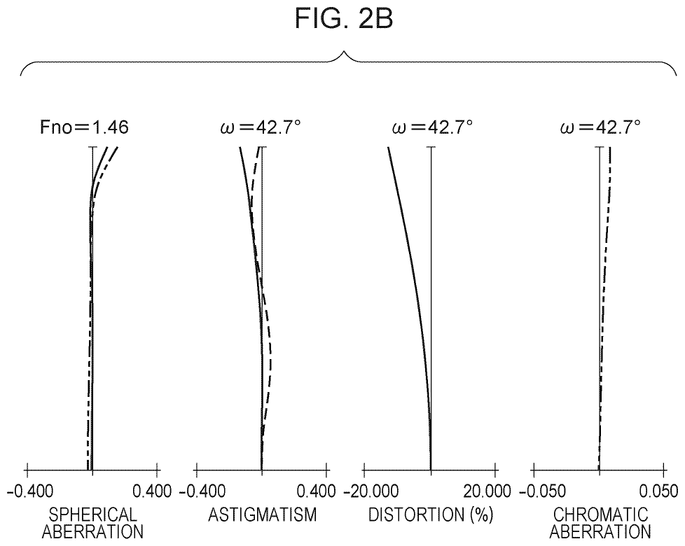

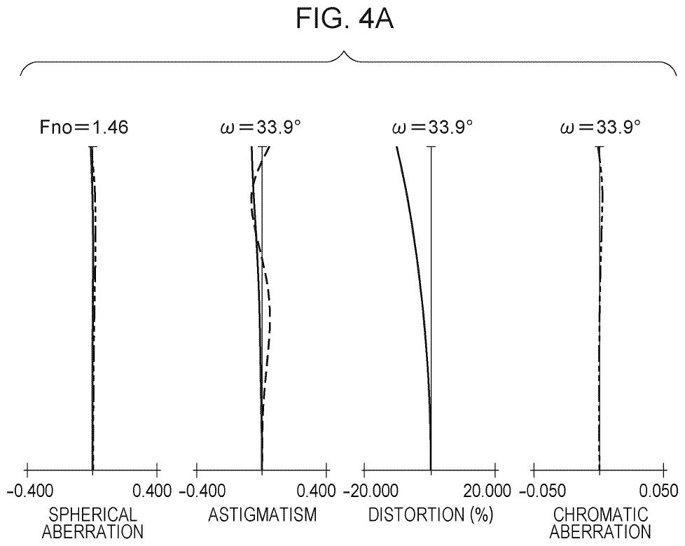

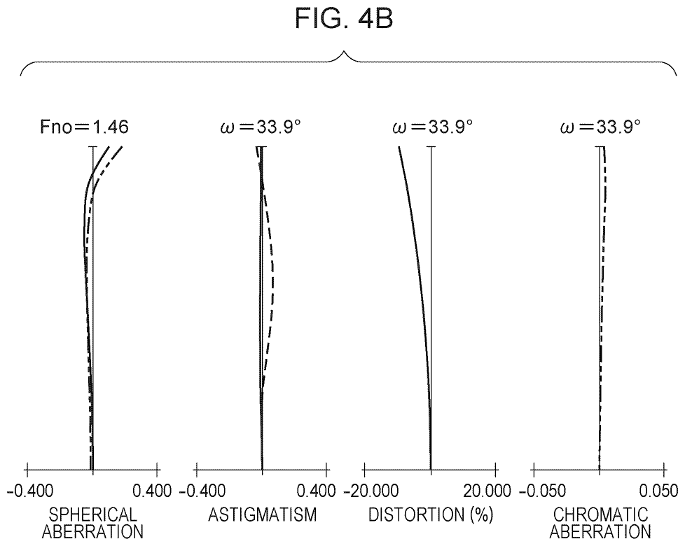

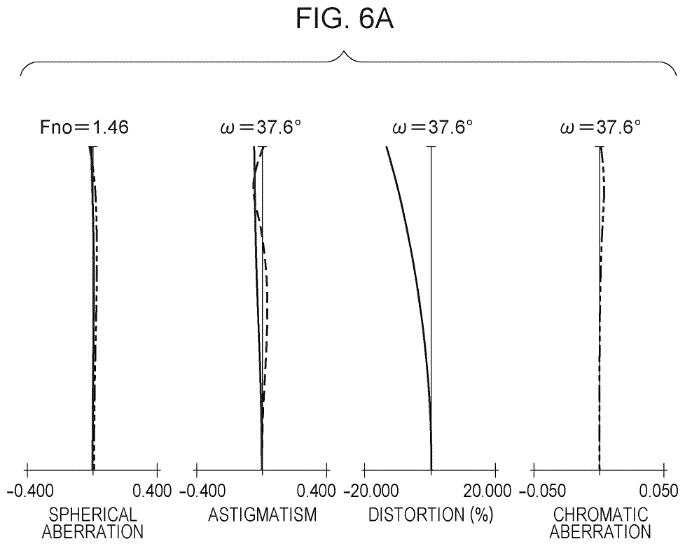

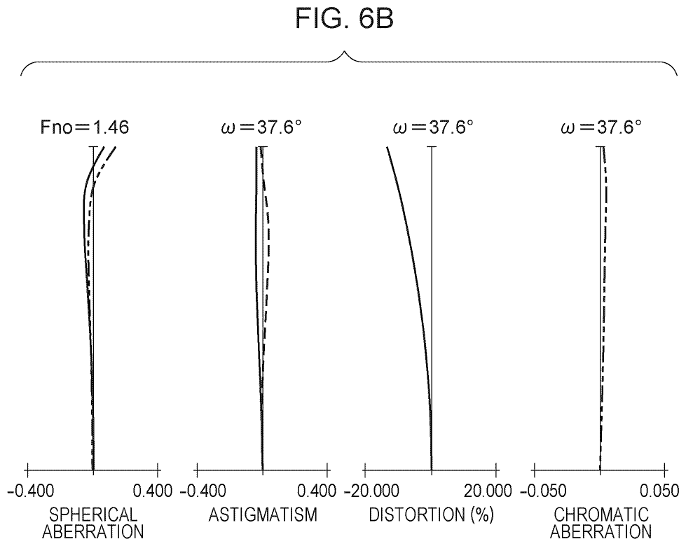

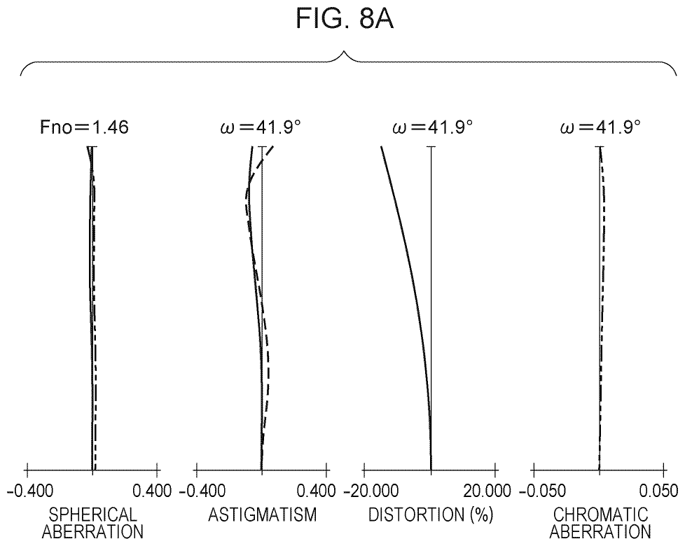

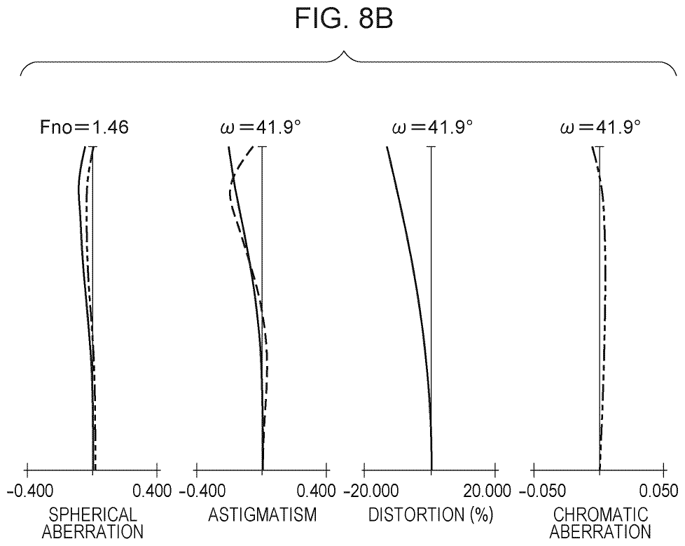

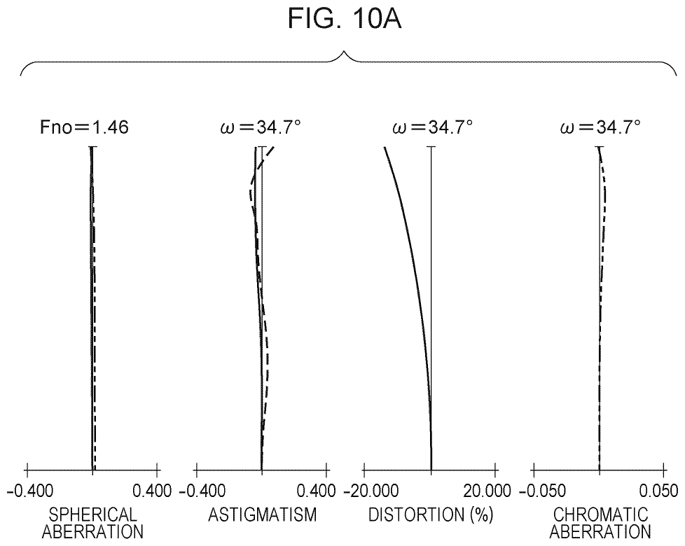

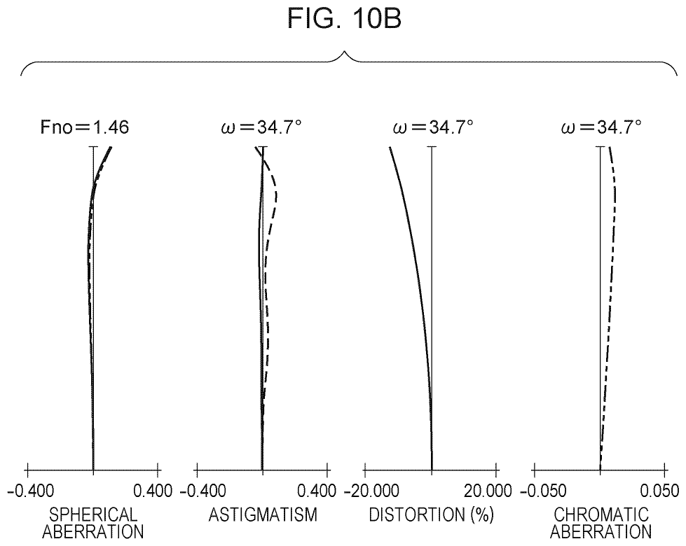

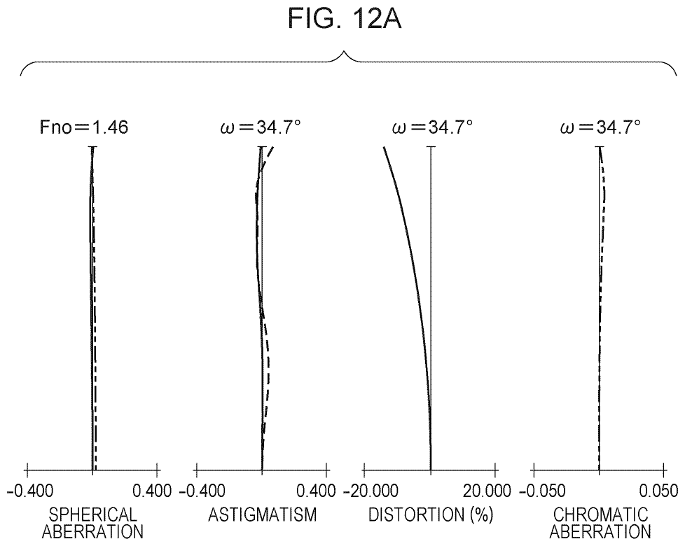

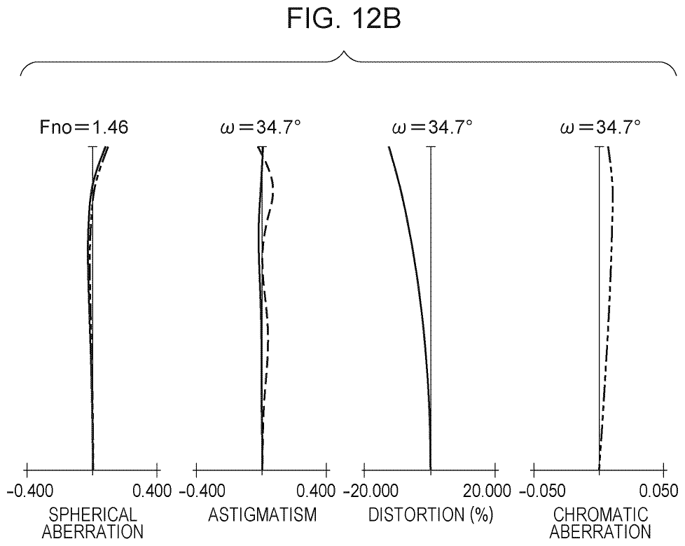

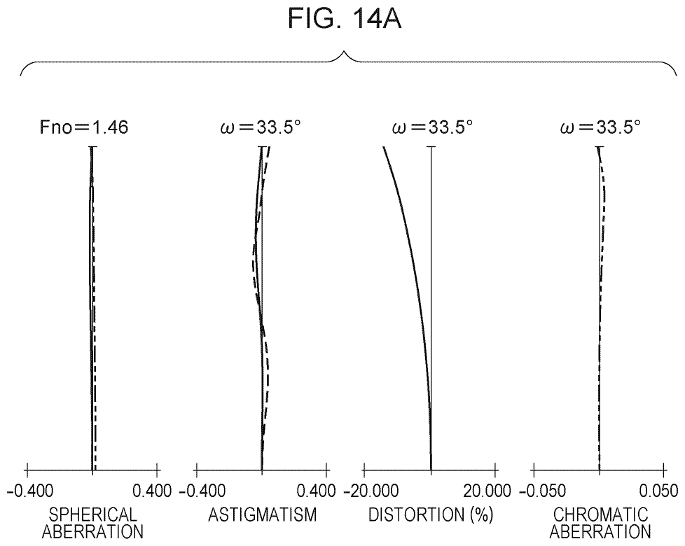

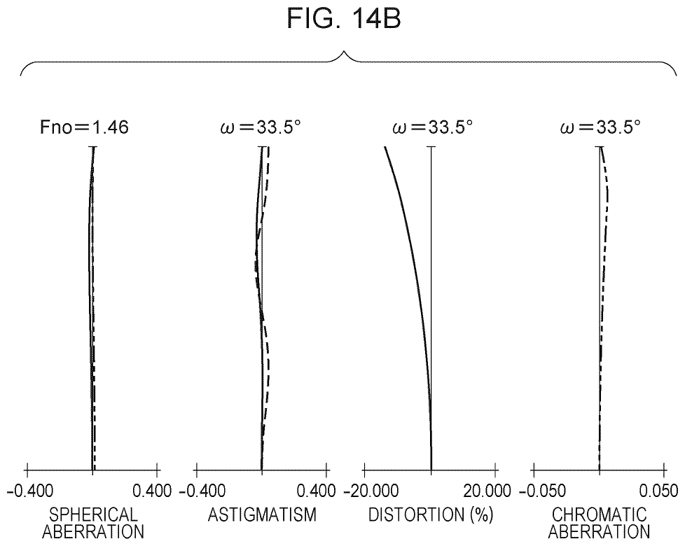

FIGS. 2A, 4A, 6A, 8A, 10A, 12A, and 14A show aberration diagrams of the optical systems according to the first to seventh embodiments when the optical systems are focused at infinity.

FIGS. 2B, 4B, 6B, 8B, 10B, 12B, and 14B show aberration diagrams of the optical systems according to the first to seventh embodiments when focused at close range.

In the spherical aberration diagrams, Fno is the F-number, and the solid and dashed lines respectively show the amounts of spherical aberrations for the d-line (wavelength 587.6 nm) and the g-line (wavelength 435.8 nm). In the astigmatism diagrams, the solid line shows the amount of astigmatism in the sagittal image plane, and the dashed line shows the amount of astigmatism in the meridional image plane. The distortion diagrams show the amount of distortion for the d-line. The chromatic aberration diagrams show the amount of lateral chromatic aberration for the g-line. In addition, @ is the imaging half angle of view) (°.

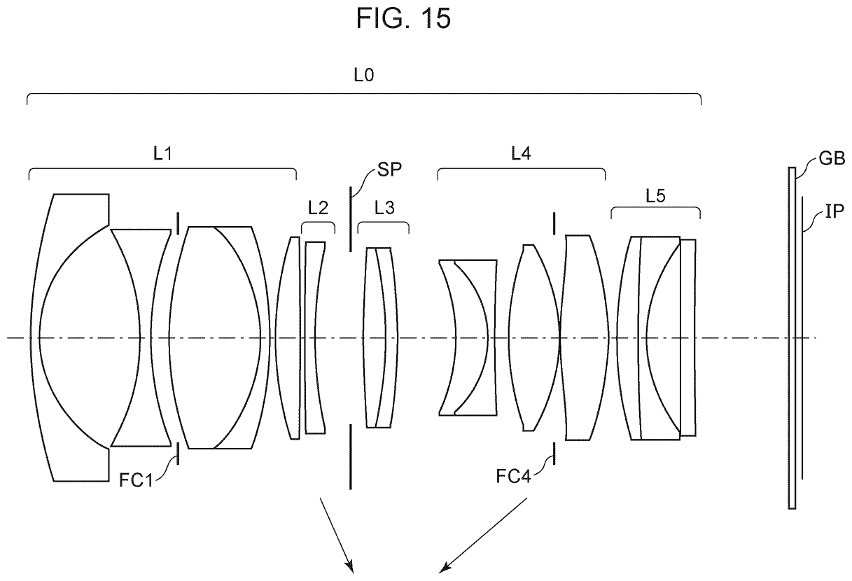

FIG. 15 shows the optical system L0 according to the first embodiment including flare cut-off stops for blocking light rays. FC1 denotes a flare cut-off stop disposed in the first lens unit L1, and FC4 denotes a flare cut-off stop disposed in the fourth lens unit LA.

Characteristic structures of the optical systems according to the embodiments will now be described.

The optical system L0 of each embodiment includes a first lens unit L1, a second lens unit L2 having a negative refractive power, a third lens unit L3, and a fourth lens unit L4 having a positive refractive power arranged in that order from the object side to the image side. Intervals between adjacent ones of the lens units change during focusing. Since the lens units move during focusing, variations in aberrations during focusing can be reduced.

During focusing from infinity to close range, the second lens unit L2 moves toward the image side, and the fourth lens unit L4 moves toward the object side. The second lens L2 and the fourth lens unit LA, which have refractive powers of different signs, move so that the interval between the second lens L2 and the fourth lens unit LA along an optical axis decreases. As a result, during focusing from infinity to close range, variations in the incident height of the off-axis ray on each lens unit can be reduced, so that variations in the angle of view during focusing from infinity to close range can be reduced.

The optical system L0 of each embodiment according to one aspect is structured to satisfy the following inequality:

$$- 10. < f 2 / f < - 3.6 \qquad ( 1 )$$

Here, f2 is the focal length of the second lens unit L2, and f is the focal length of the entire system.

Inequality (1) is set to reduce the variations in the aberrations and the angle of view during focusing and achieve a size reduction.

When the value of Inequality (1) is above the upper limit, the refractive power of the second lens unit L2 is too strong. As a result, the variation in the angle of view during focusing becomes too large. When the value of Inequality (1) is below the lower limit, the refractive power of the second lens unit L2 is too weak. Therefore, the amount of movement of the second lens unit L2 for focusing from infinity to a desired object distance becomes too large. As a result, the overall lens length increases.

Here, the overall lens length is the sum of the distance from a surface of the optical system L0 closest to the object side to a surface of the optical system L0 closest to the image side along the optical axis and a back focal length. The back focal length is a value obtained by air conversion of the distance between the surface of the optical system L0 closest to the image side and the image plane along the optical axis.

At least one of the upper and lower limits of the numerical range of Inequality (1) may be changed as in Inequality (1a):

$$- 9.5 < f 2 / f < - 3.7 \qquad ( 1 a )$$

At least one of the upper and lower limits of the numerical range of Inequality (1) may also be changed as in Inequality (1b):

$$- 9. < f 2 / f < - 3.8 \qquad ( 1 b )$$

The optical system L0 of each embodiment according to another aspect is structured such that the first lens unit L1 includes a negative meniscus lens having a convex surface facing the object side and a positive lens.

When the first lens unit L1 includes the negative meniscus lens having a convex surface facing the object side and the positive lens, variations in the lateral chromatic aberration and the distortion of the first lens unit L1 during focusing from infinity to close range can be reduced.

The structure of the optical system L0 according to each embodiment will now be described.

During image blur correction, the entirety or part of a lens element included in the third lens unit L3 may be moved in a direction including a component perpendicular to the optical axis. To obtain the amount of peripheral light desired during image blur correction, the diameter of the lens moved during image blur correction is increased. Therefore, by moving the lens element of the third lens unit L3 having a relatively small diameter, an increase in the diameter of the optical system L0 can be suppressed.

Here, the lens element represents a single lens or a plurality of lenses.

The optical system L0 of each embodiment may satisfy one or more of the following inequalities:

$$\begin{matrix}- 3.5 < M 2 / M 4 < - 0.5 & ( 2 ) \\ - 7. < f 2 / f 4 < - 2.5 & ( 3 ) \\ 0.05 < \vert f 1 / f 2 \vert < 0.5 & ( 4 ) \\ 2. < \vert fR / f \vert < 500. & ( 5 ) \\ 0.3 < BF / f < 1.5 & ( 6 ) \\ 0.45 < Da / TL < 0.7 & ( 7 ) \\ 0.15 < D 4 / Da < 0.35 & ( 8 ) \\ 0.7 < ( 1 - {β4}^{2} ) \times β {R}^{2} < 3. & ( 9 ) \\ 70. < v 4 p < 96. & ( 10 )\end{matrix}$$

Here, M2 and M4 are the amounts of movement of the second lens unit L2 and the fourth lens unit LA, respectively, during focusing from infinity to an object distance at which the lateral magnification of the entire system is −0.1. The sign of the amount of movement is positive for a movement toward the image side.

In addition, f4 is the focal length of the fourth lens unit LA, and f1 is the focal length of the first lens unit L1.

In addition, fR is the focal length of a lens unit closest to the image side in the optical system L0, and BF is the back focal length when the optical system is L0 focused at infinity.

The optical system L0 includes the aperture stop SP. In this case, Da is the distance from the aperture stop SP to the image plane along the optical axis when the optical system L0 is focused at infinity. TL is the overall lens length of the optical system L0. D4 is the distance from the aperture stop SP to a surface of the fourth lens unit LA closest to the object side along the optical axis.

In addition, β4 is the lateral magnification of the fourth lens unit LA when the optical system L0 is focused is at infinity, and βR is the combined lateral magnification of all lens units disposed on the image side of the fourth lens unit LA when the optical system L0 is focused at infinity.

In addition, ν4p is the Abbe number of at least one positive lens included in the fourth lens unit LA.

The technical meaning of Inequalities (2) to (10) will now be described.

When the amount of movement of the fourth lens unit L4 is too large such that the value of Inequality (2) is above the upper limit, the variation in the incident height of the off-axis ray on each lens unit during focusing from infinity to close range increases. As a result, the variation in the angle of view during focusing from infinity to close range increases. Also when the value of Inequality (2) is below the lower limit, the amount of movement of the second lens unit L2 is too large, and the variation in the incident height of the off-axis ray on each lens unit during focusing from infinity to close range increases. As a result, the variation in the angle of view during focusing from infinity to close range increases.

When the value of Inequality (3) is above the upper limit, the refractive power of the second lens unit L2 is too strong. As a result, the variation in the angle of view during focusing becomes too large. When the value of Inequality (3) is below the lower limit, the refractive power of the fourth lens unit LA is too strong. As a result, the variations in the angle of view and the field curvature during focusing become too large.

When the value of Inequality (4) is above the upper limit, the refractive power of the first lens unit L1 is too weak. As a result, the overall lens length and the diameter of the first lens unit L1 increase. When the value of Inequality (4) is below the lower limit, the refractive power of the first lens unit L1 is too strong. As a result, the spherical aberration, the lateral chromatic aberration, etc., cannot be easily corrected.

When the value of Inequality (5) is above the upper limit, the refractive power of the lens unit closest to the image side in the optical system L0 is too weak. As a result, the aberrations of each of the lens units included in the optical system L0 cannot be easily corrected. When the value of Inequality (5) is below the lower limit, the refractive power of the lens unit closest to the image side is too strong. As a result, the field curvature, the lateral chromatic aberration, etc., of the lens unit closest to the image side cannot be easily corrected.

When the back focal length is increased such that the value of Inequality (6) is above the upper limit, the overall lens length is too long. When the back focal length is reduced such that the value of Inequality (6) is below the lower limit, ghost light generated by reflection between an imaging device that is installed and an image-side surface of the lens closest to the image side easily forms an image on the imaging device.

When the aperture stop SP is disposed close to the object side in the optical system L0 such that the value of Inequality (7) is above the upper limit, the diameter of the lens unit disposed closest to the image side increases. When the aperture stop SP is disposed close to the image side in the optical system L0 such that the value of Inequality (7) is below the lower limit, the diameter of the first lens unit L1 increases.

When the distance from the aperture stop SP to the surface of the fourth lens unit LA closest to the object side along the optical axis is increased such that the value of Inequality (8) is above the upper limit, the fourth lens unit LA is disposed at a position where the off-axis ray is at a large height from the optical axis. As a result, the variation in the angle of view during focusing increases.

When the distance from the aperture stop SP to the surface of the fourth lens unit LA closest to the object side along the optical axis is reduced such that the value of Inequality (8) is below the lower limit, the fourth lens unit LA is disposed at a position where the on-axis ray is at a large height from the optical axis. As a result, the variation in the spherical aberration during focusing increases.

Inequality (9) involves the sensitivity to the position of the fourth lens unit L4, that is, the displacement of the image plane in response to a unit displacement of the fourth lens unit LA in the direction of the optical axis. When the sensitivity to the position of the fourth lens unit LA is increased such that the value of Inequality (9) is above the upper limit, the refractive power of the fourth lens unit LA is too strong. As a result, the variations in the aberrations during focusing become too large.

When the sensitivity to the position of the fourth lens unit LA is reduced such that the value of Inequality (9) is below the lower limit, the amount of movement of the second lens unit L2 for focusing from infinity to a desired object distance becomes too large. As a result, the overall lens length increases.

When the value of Inequality (10) is above the upper limit, the refractive index of the at least one positive lens included in the fourth lens unit L4 is too low, and the field curvature, for example, cannot be easily corrected.

When the value of Inequality (10) is below the lower limit, the Abbe number of the at least one positive lens included in the fourth lens unit LA is too small, and the lateral chromatic aberration, for example, cannot be easily corrected.

At least one of the upper and lower limits of the numerical ranges of Inequalities (2) to (10) may be changed as follows:

$$\begin{matrix}- 3.3 < M 2 / M 4 < - 0.6 & ( 2 a ) \\ - 6.9 < f 2 / f 4 < - 2.55 & ( 3 a ) \\ 0.1 < \vert f 1 / f 2 \vert < 0.47 & ( 4 a ) \\ 2.1 < \vert fR / f \vert < 450. & ( 5 a ) \\ 0.35 < BF / f < 1.3 & ( 6 a ) \\ 0.5 < Da / TL < 0.67 & ( 7 a ) \\ 0.17 < D 4 / Da < 0.33 & ( 8 a ) \\ 0.75 < ( 1 - {β4}^{2} ) \times β {R}^{2} < 2.8 & ( 9 a ) \\ 72. < v 4 p < 95.5 & ( 10 a )\end{matrix}$$

At least one of the upper and lower limits of the numerical ranges of Inequalities (2) to (10) may also be changed as follows:

$$\begin{matrix}- 3.1 < M 2 / M 4 < - 0.7 & ( 2 b ) \\ - 6.8 < f 2 / f 4 < - 2.6 & ( 3 b ) \\ 0.15 < \vert f 1 / f 2 \vert < 0.45 & ( 4 b ) \\ 2.2 < \vert fR / f \vert < 400. & ( 5 b ) \\ 0.4 < BF / f < 1.2 & ( 6 b ) \\ 0.55 < Da / TL < 0.65 & ( 7 b ) \\ 0.2 < D 4 / Da < 0.31 & ( 8 b ) \\ 0.78 < ( 1 - {β4}^{2} ) \times β {R}^{2} < 2.5 & ( 9 b ) \\ 75. < v 4 p < 95. & ( 10 b )\end{matrix}$$

The detailed structure of the optical system L0 of each embodiment will now be described. For the second and following embodiments, differences from the first embodiment will be mainly described.

### First Embodiment

The optical system L0 of the first embodiment includes lens units having positive, negative, positive, positive, and negative refractive powers arranged in that order from the object side to the image side. The intervals between adjacent ones of the lens units change during focusing. The lens units having positive refractive powers and the lens units having negative refractive powers are appropriately arranged so that the variations in the aberrations during focusing can be reduced.

During focusing from infinity to close range, the second lens unit L2 moves toward the image side, and the fourth lens unit L4 moves toward the object side, so that the variation in the incident height of the off-axis ray on each lens unit is reduced. Accordingly, the variation in the angle of view during focusing from infinity to close range is reduced.

The second lens unit L2 includes a negative meniscus lens having a convex surface facing the object side. Therefore, a weight reduction is achieved, and the variation in the spherical aberration during focusing is reduced.

### Second Embodiment

The fourth lens unit LA according to the second embodiment includes a negative meniscus lens having a convex surface facing the image side. Accordingly, the variation in the field curvature during focusing can be easily reduced.

### Third Embodiment

The optical system L0 of the third embodiment includes a negative meniscus lens disposed closest to the image side and having a convex surface facing the image side. Accordingly, the field curvature can be easily corrected.

### Fourth Embodiment

The optical system L0 of the fourth embodiment includes lens units having negative, negative, positive, positive, and negative refractive powers arranged in that order from the object side to the image side. The intervals between adjacent ones of the lens units change during focusing.

The first lens unit L1 according to the fourth embodiment includes a positive meniscus lens having a convex surface facing the object side. Accordingly, the spherical aberration can be easily corrected.

### Fifth Embodiment

The optical system L0 of the fifth embodiment includes lens units having positive, negative, positive, positive, negative, and negative refractive powers arranged in that order from the object side to the image side. The intervals between adjacent ones of the lens units change during focusing.

During focusing from infinity to close range, the second lens unit L2 moves toward the image side, the fourth lens unit L4 moves toward the object side, and the fifth lens unit L5 moves along a locus that is convex toward the object side. Since three lens units move during focusing from infinity to close range, the variations in the aberrations can be easily reduced.

Since the fifth lens unit L5 and the sixth lens unit L6 have negative refractive powers, the overall lens length can be easily reduced by positioning the principal point of the optical system L0 on the object side.

### Sixth Embodiment

The optical system L0 of the sixth embodiment includes lens units having positive, negative, positive, positive, negative, and positive refractive powers arranged in that order from the object side to the image side. The intervals between adjacent ones of the lens units change during focusing.

During focusing from infinity to close range, the second lens unit L2 moves toward the image side, the fourth lens unit L4 moves toward the object side, and the fifth lens unit L5 moves along a locus that is convex toward the object side. Since three lens units move during focusing from infinity to close range, the variations in the aberrations can be easily reduced.

Since the fifth lens unit L5 and the sixth lens unit L6 have refractive powers of different signs, the lateral chromatic aberrations and the field curvatures of the fifth lens unit L5 and the sixth lens unit L6 easily cancel each other.

### Seventh Embodiment

The optical system L0 of the seventh embodiment includes lens units having positive, negative, positive, positive, and positive refractive powers arranged in that order from the object side to the image side. The intervals between adjacent ones of the lens units change during focusing.

Since the fifth lens unit L5 has a positive refractive power, the incident angle of light rays relative to the direction normal to the image plane can be reduced, so that color misregistration (color shading) that occurs when the imaging device is disposed can be easily reduced.

In the optical system L0 of each embodiment, a positive lens and a negative lens forming a cemented lens may be bonded together with an adhesive having a thickness of 0.005 mm or more and 0.050 mm or less along the optical axis. When the thickness is less than 0.005 mm, the lenses easily separate. When the thickness is greater than 0.030 mm, the distance from a surface of the cemented lens closest to the object side to a surface of the cemented lens closest to the image side along the optical axis increases, and therefore the overall lens length increases. The thickness may be 0.008 mm or more and 0.020 mm or less.

An antireflection film for preventing reflection may be applied to at least one of the lenses included in the optical system L0 of each embodiment. The antireflection film may include a plurality of layers.

When Nd is the refractive index of the layer closest to the air interface for the d-line, an antireflection film PC having Nd of 1.32 or less may be used. When Nd is 1.32 or less, the difference in refractive index between the layer and air can be reduced. Therefore, the reflectance of light can be further reduced, and ghost can be reduced accordingly.

Examples of structures of the antireflection film PC include multilayer films formed by the wetting method described in Japanese Patent Laid-Open No. 2012-230211 and Japanese Patent Laid-Open No. 2014-95877. However, the antireflection film PC is not limited to these examples. When Nd is 1.30 or less, ghost can be further reduced.

When a lens A is the lens closest to the object side and a lens B is the lens second closest to the object side among the negative lenses included in the optical system L0 and having concave surfaces facing the image side, the antireflection film PC may be applied to an image-side surface of the lens A or the lens B. The image-side surfaces of the lens A and the lens B tend to have large aperture angles, and light reflected in an area having a large aperture angle tends to have a large reflection angle relative to the direction normal to the lens surface. Therefore, the reflectance is easily increased.

In addition, light reflected by a negative lens having a concave surface facing the image side is easily condensed on the image plane, and therefore ghost is easily noticeable. Therefore, ghost can be reduced by applying the antireflection film PC to the image-side surface of the lens A or the lens B.

In each embodiment, a flare cut-off stop that blocks light rays may be provided. FIG. 15 illustrates the optical system L0 according to the first embodiment including flare cut-off stops. A structure including flare cut-off stops will be described below with reference to FIG. 15.

The first lens unit L1 may include at least one flare cut-off stop FC1. Accordingly, in FIG. 15, a lower line of the off-axis marginal ray incident on the first lens unit L1 from a lower position on the object side can be appropriately blocked, so that the comatic aberration can be reduced.

The fourth lens unit L4 may include at least one flare cut-off stop FC4. Accordingly, in FIG. 15, an upper line of the off-axis marginal ray incident on the first lens unit L1 from a lower position on the object side can be appropriately blocked, so that the comatic aberration can be reduced.

The above-described arrangement of the flare cut-off stops is not limited to the first embodiment, and may similarly be applied to the second to seventh embodiments to reduce the comatic aberration.

First to seventh numerical examples corresponding to the first to seventh embodiments will now be described.

In the surface data of each numerical example, r represents the radius of curvature of each optical surface, d (mm) is the interval along the axis (distance along the optical axis) between the m^{th} and (m+1)^{th} surfaces, where m is the number of each surface counted from the light incident side. Also, nd is the refractive index of each optical member for the d-line, and νd is the Abbe number of each optical member. When Nd, NF, and NC are the refractive indices of a certain material for the d-line (wavelength 587.6 nm), the F-line (wavelength 486.1 nm), and the C-line (wavelength 656.3 nm), respectively, of the Fraunhofer lines, the Abbe number νd of the material can be expressed as follows:

$$vd = ( Nd - 1 ) / ( NF - NC )$$

BF represents the back focal length.

The symbol ‘*’ is attached to the right side of the surface number when the corresponding optical surface is an aspheric surface. When X is the displacement from the vertex of a surface in the direction of the optical axis, h is the height from the optical axis in a direction perpendicular to the optical axis, r is the paraxial radius of curvature, k is the conic constant, and A4, A6, A8, A10, and A12 are aspheric coefficients of the respective orders, an aspheric surface can be represented by the following equation:

$$x = ( {h}^{2} / R ) / [ 1 + {\{ 1 - ( 1 + k ) {( h / R )}^{2} \}}^{1 / 2} ] + A 4 \times {h}^{4} + A 6 \times {h}^{6} + A 8 \times {h}^{8} + A 1. \times {h}^{10} + A 12 \times {h}^{12}$$

For each of the aspheric coefficients, “e±XX” means “×10±XX”.

The lens structure length of each lens unit is the distance from a surface closest to the object side to a surface closest to the image side along the optical axis.

In the various data, intervals between adjacent ones of the lens units along the optical axis when the lateral magnification of the entire system is 0.0 (INF), −0.1, close range, etc., are shown. INF represents infinity.

### First Numerical Example

### Unit of Measure mm

### Surface Data

| Surface Number | r | d | nd | νd |
|---|---|---|---|---|
| 1 | 72.978 | 1.30 | 1.59349 | 67.0 |
| 2* | 19.349 | 14.73 | | |
| 3 | −34.011 | 1.50 | 1.59678 | 66.9 |
| 4 | 45.153 | 2.74 | | |
| 5 | 50.272 | 13.45 | 1.76385 | 48.5 |
| 6 | −23.235 | 1.30 | 1.85478 | 24.8 |
| 7 | −52.852 | 0.72 | | |
| 8 | 54.430 | 3.79 | 2.00107 | 28.9 |
| 9 | −332.088 | (variable) | | |
| 10 | 800.000 | 1.50 | 1.61120 | 44.5 |
| 11 | 72.250 | (variable) | | |
| 12 (stop) | ∞ | 1.86 | | |
| 13 | 182.727 | 3.29 | 1.76385 | 48.5 |
| 14 | −64.432 | 1.75 | 1.72047 | 34.7 |
| 15 | −83.994 | (variable) | | |
| 16 | −28.776 | 4.69 | 1.49700 | 81.5 |
| 17 | −15.444 | 1.00 | 1.77047 | 29.7 |
| 18 | 246.210 | 2.00 | | |
| 19 | 41.743 | 7.52 | 1.49700 | 81.5 |
| 20 | −28.002 | 0.20 | | |
| 21* | 71.189 | 6.98 | 1.80400 | 46.5 |
| 22* | −41.928 | (variable) | | |
| 23 | 58.473 | 3.10 | 1.92286 | 20.9 |
| 24 | 384.629 | 1.25 | 1.77047 | 29.7 |
| 25 | 24.024 | 5.01 | | |
| 26 | −2493.166 | 2.00 | 1.77043 | 29.7 |
| 27 | 692.822 | 13.78 | | |
| 28 | ∞ | 1.00 | 1.51633 | 64.1 |
| 29 | ∞ | 1.00 | | |
| Image Plane | ∞ | | | |

### Aspheric Surface Data

### 2nd Surface

$$K = 0. e + 00 A 4 = - 1.54852 e - 06 A 6 = - 1.39851 e - 08 A 8 = 4.03181 e - 11 A 10 = - 1.18272 e - 13$$

### 21 st Surface

$$K = 0. e + 00 A 4 = - 1.44287 e - 05 A 6 = - 1.34545 e - 08 A 8 = 2.95087 e - 11 A 10 = - 3.61239 e - 13 A 12 = 6.97332 e - 16$$

### 22nd Surface

$$K = 0. e + 00 A 4 = 5.35853 e - 06 A 6 = - 2.5632 e - 08 A 8 = 1.20016 e - 10 A 10 = - 4.84989 e - 13 A 12 = 8.09237 e - 16$$

### Various Data

Focal Length 20.63
F-Number 1.46
Angle of View 42.73
Overall Length of Lenses 112.63
BF 15.44

Lateral Magnification of Entire System 0.00
(INF) −0.020 −0.10 −0.14

| | | | | |
|---|---|---|---|---|
| d 9 | 0.60 | 1.06 | 2.94 | 3.79 |
| d11 | 5.19 | 4.73 | 2.84 | 2.00 |
| d15 | 8.53 | 8.30 | 7.29 | 6.79 |
| d22 | 1.20 | 1.43 | 2.43 | 2.94 |

### Lens Unit Data

| Unit | Start Surface | Focal Length | Lens Structure Length |
|---|---|---|---|
| L1 | 1 | 42.82 | 39.54 |
| L2 | 10 | −130.05 | 1.50 |
| L3 | 12 | 75.09 | 6.91 |
| L4 | 16 | 28.27 | 22.39 |
| L5 | 23 | −58.79 | 26.13 |

### Second Numerical Example

### Unit of Measure mm

### Surface Data

| Surface Number | r | d | nd | νd |
|---|---|---|---|---|
| 1 | 66.406 | 1.30 | 1.59349 | 67.0 |
| 2* | 23.697 | 15.11 | | |
| 3 | −29.349 | 1.20 | 1.49815 | 62.7 |
| 4 | 73.097 | 2.32 | | |
| 5 | 85.690 | 10.64 | 1.76385 | 48.5 |
| 6 | −23.402 | 1.30 | 1.85478 | 24.8 |
| 7 | −48.343 | 0.20 | | |
| 8 | 58.989 | 4.89 | 2.00098 | 28.6 |
| 9 | −151.967 | (variable) | | |
| 10 | 163.200 | 1.50 | 1.61314 | 44.3 |
| 11 | 51.990 | (variable) | | |
| 12 (stop) | ∞ | 5.44 | | |
| 13 | 226.152 | 6.34 | 1.76385 | 48.5 |
| 14 | −22.862 | 1.10 | 1.72047 | 34.7 |
| 15 | −412.253 | (variable) | | |
| 16 | −30.434 | 5.20 | 1.49700 | 81.5 |
| 17 | −16.763 | 1.00 | 1.77047 | 29.7 |
| 18 | −269.583 | 2.09 | | |
| 19 | 53.782 | 7.99 | 1.49700 | 81.5 |
| 20 | −31.544 | 0.53 | | |
| 21* | 162.397 | 6.89 | 1.80400 | 46.5 |
| 22* | −44.046 | (variable) | | |
| 23 | 118.583 | 5.99 | 1.92286 | 20.9 |
| 24 | −61.303 | 1.74 | 1.77047 | 29.7 |
| 25 | 45.530 | 5.00 | | |
| 26 | −77.584 | 1.76 | 1.39156 | 32.0 |
| 27 | 145.502 | 12.97 | | |
| 28 | ∞ | 1.00 | 1.51633 | 64.1 |
| 29 | ∞ | 1.00 | | |
| Image Plane | ∞ | | | |

### Image Plane ∞

### Aspheric Surface Data

### 2nd Surface

$$K = 0. e + 00 A 4 = 6.14218 e - 07 A 6 = 5.2854 e - 09 A 8 = - 2.2184 e - 11 A 10 = 6.93534 e - 14$$

### 21 st Surface

$$K = 0. e + 00 A 4 = - 8.89677 e - 06 A 6 = - 5.76603 e - 09 A 8 = 2.46003 e - 11 A 10 = - 1.0898 e - 13 A 12 = 1.29068 e - 16$$

### 22nd Surface

$$K = 0. e + 00 A 4 = 2.85669 e - 06 A 6 = - 6.12974 e - 09 A 8 = 2.49444 e - 11 A 10 = - 5.50422 e - 14 A 12 = 4.82648 e - 17$$

### Various Data

Focal Length 28.80
F-Number 1.46
Angle of View 33.89
Overall Length of Lenses 119.74
BF 14.63

Lateral Magnification of Entire System 0.00
(INF) −0.026 −0.10 −0.19

| | | | | |
|---|---|---|---|---|
| d 9 | 0.60 | 1.24 | 2.90 | 4.65 |
| d11 | 7.35 | 6.71 | 5.05 | 3.30 |
| d15 | 6.43 | 5.95 | 4.53 | 2.52 |
| d22 | 1.20 | 1.68 | 3.10 | 5.11 |

### Lens Unit Data

| Unit | Start Surface | Focal Length | Lens Structure Length |
|---|---|---|---|
| L1 | 1 | 38.08 | 36.95 |
| L2 | 10 | −125.07 | 1.50 |
| L3 | 12 | 143.42 | 12.88 |
| L4 | 16 | 35.48 | 23.71 |
| L5 | 23 | −72.03 | 28.46 |

### Third Numerical Example

### Unit of Measure mm

| Surface Number | r | d | nd | vd |
|---|---|---|---|---|
| 1 | 72.288 | 1.30 | 1.59349 | 67.0 |
| 2 | 21.526 | 13.44 | | |
| 3 | −29.716 | 1.22 | 1.54814 | 45.8 |
| 4 | 57.813 | 3.61 | | |
| 5 | 84.776 | 10.56 | 1.76385 | 48.5 |
| 6 | −23.162 | 1.30 | 1.85478 | 24.8 |
| 7 | −45.112 | 0.19 | | |
| 8 | 60.450 | 4.94 | 2.00069 | 25.5 |
| 9 | −152.845 | (variable) | | |
| 10 | 147.080 | 1.49 | 1.62004 | 36.3 |
| 11 | 60.717 | (variable) | | |
| 12 (stop) | ∞ | 1.99 | | |
| 13 | 1242.125 | 7.29 | 1.76385 | 48.5 |
| 14 | −21.123 | 1.09 | 1.72047 | 34.7 |
| 15 | −166.674 | (variable) | | |
| 16 | −33.613 | 5.21 | 1.49700 | 81.5 |
| 17 | −15.879 | 1.00 | 1.77047 | 29.7 |
| 18 | 834.948 | 1.99 | | |
| 19 | 49.688 | 8.75 | 1.49700 | 81.5 |
| 20 | −30.861 | 0.20 | | |
| 21* | 80.138 | 7.00 | 1.80400 | 46.5 |
| 22* | −47.206 | (variable) | | |
| 23 | 130.745 | 4.30 | 1.92286 | 20.9 |
| 24 | −78.962 | 1.25 | 1.77047 | 29.7 |
| 25 | 44.799 | 4.93 | | |
| 26 | −80.385 | 1.20 | 1.65412 | 39.7 |
| 27 | −289.464 | 13.52 | | |
| 28 | ∞ | 1.00 | 1.51633 | 64.1 |
| 29 | ∞ | 1.00 | | |
| Image Plane | ∞ | | | |

### Aspheric Surface Data

### 21st Surface

$$K = 0. e + 00 A 4 = - 7.6813 e - 06 A 6 = - 9.12882 e - 10 A 8 = 2.65012 e - 11 A 10 = - 7.89662 e - 14 A 12 = 1.31928 e - 16$$

### 22nd Surface

$$K = 0. e + 00 A 4 = 4.42473 e - 06 A 6 = - 2.12367 e - 09 A 8 = 3.53558 e - 11 A 10 = - 6.57718 e - 14 A 12 = 1.35297 e - 16$$

### Various Data

Focal Length 24.72
F-Number 1.46
Angle of View 37.14
Overall Length of Lenses 118.17
BF 15.18

Lateral Magnification of Entire System 0.00
(INF) −0.022 −0.10 −0.17

| | | | | |
|---|---|---|---|---|
| d 9 | 1.20 | 1.69 | 3.37 | 4.82 |
| d11 | 8.91 | 8.41 | 6.73 | 5.28 |
| d15 | 6.78 | 6.40 | 5.08 | 3.91 |
| d22 | 1.85 | 2.23 | 3.55 | 4.73 |

### Lens Unit Data

| Unit | Start Surface | Focal Length | Lens Structure Length |
|---|---|---|---|
| L1 | 1 | 38.50 | 36.56 |
| L2 | 10 | −167.88 | 1.49 |
| L3 | 12 | 143.52 | 10.38 |
| L4 | 16 | 31.67 | 24.14 |
| L5 | 23 | −72.41 | 26.19 |

### Fourth Numerical Example

### Unit of Measure mm

| Surface Number | r | d | nd | vd |
|---|---|---|---|---|
| 1 | 47.721 | 1.30 | 1.59349 | 67.0 |
| 2* | 21.373 | 13.33 | | |
| 3 | −61.952 | 1.18 | 1.49700 | 81.5 |
| 4 | 31.860 | 4.92 | | |
| 5 | 1053.852 | 8.08 | 1.91082 | 35.2 |
| 6 | −23.698 | 1.30 | 1.84666 | 23.9 |
| 7 | −103.763 | 0.18 | | |
| 8 | 34.315 | 4.93 | 1.85478 | 24.8 |
| 9 | 47.457 | (variable) | | |
| 10 | 2234.784 | 1.44 | 1.61340 | 44.3 |
| 11 | 105.403 | (variable) | | |
| 12 (stop) | ∞ | 1.44 | | |
| 13 | 72.289 | 7.46 | 1.90043 | 37.4 |
| 14 | −29.201 | 1.49 | 1.54814 | 45.8 |
| 15 | 323.072 | (variable) | | |
| 16 | −35.927 | 6.57 | 1.49700 | 81.5 |
| 17 | −15.755 | 1.00 | 1.77047 | |
| 18 | −59.765 | 1.98 | | |
| 19 | 30.174 | 9.15 | 1.49700 | 81.5 |
| 20 | −35.862 | 0.16 | | |
| 21* | 245.125 | 5.40 | 1.80400 | 46.5 |
| 22* | −44.909 | (variable) | | |
| 23 | −306.228 | 2.58 | 1.92286 | 20.9 |
| 24 | −63.551 | 2.01 | 1.77047 | 29.7 |
| 25 | 25.357 | 1.91 | | |
| 26 | 44.412 | 3.91 | 1.73800 | 32.3 |
| 27 | 141.498 | 19.03 | | |
| 28 | ∞ | 1.00 | 1.51633 | 64.1 |
| 29 | ∞ | 2.08 | | |
| Image Plane | ∞ | | | |

### Aspheric Surface Data

### 2nd Surface

$$K = 0. e + 00 A 4 = - 7.52192 e - 07 A 6 = - 6.39173 e - 09 A 8 = 1.90775 e - 11 A 10 = - 4.34826 e - 14$$

### 21 st Surface

$$K = 0. e + 00 A 4 = - 1.59674 e - 05 A 6 = 1.32646 e - 09 A 8 = - 1.63157 e - 10 A 10 = 1.83632 e - 12 A 12 = - 4.38378 e - 15$$

### 22nd Surface

$$K = 0. e + 00 A 4 = 4.5578 e - 06 A 6 = - 5.06476 e - 09 A 8 = 5.47838 e - 12 A 10 = 1.16038 e - 12 A 12 = - 3.04625 e - 15$$

### Various Data

Focal Length 21.22
F-Number 1.46
Angle of View 41.03
Overall Length of Lenses 120.82
BF 21.77

Lateral Magnification of Entire System
0.00 (INF) -0.020 -0.10 -0.15

| | | | | |
|---|---|---|---|---|
| d 9 | 2.58 | 3.14 | 5.75 | 7.65 |
| d11 | 6.89 | 6.33 | 3.71 | 1.82 |
| d15 | 6.76 | 6.53 | 5.54 | 4.89 |
| d22 | 1.11 | 1.34 | 2.33 | 2.97 |

### Lens Unit Data

| Unit | Start Surface | Focal Length | Lens Structure Length |
|---|---|---|---|
| L1 | 1 | −79.50 | 35.21 |
| L2 | 10 | −180.39 | 1.44 |
| L3 | 12 | 44.73 | 10.39 |
| L4 | 16 | 26.29 | 24.25 |
| L5 | 23 | −52.20 | 30.45 |

### Fifth Numerical Example

### Unit of Measure mm

| Surface Number | r | d | nd | vd |
|---|---|---|---|---|
| 1 | 195.819 | 1.30 | 1.59349 | 67.0 |
| 2* | 25.288 | 13.99 | | |
| 3 | −26.717 | 1.20 | 1.51633 | 64.1 |
| 4 | 1357.161 | 1.46 | | |
| 5 | −1541.751 | 9.96 | 1.76385 | 48.5 |
| 6 | −24.641 | 1.30 | 1.85478 | 24.8 |
| 7 | −37.622 | 0.20 | | |
| 8 | 43.194 | 4.87 | 1.91082 | 35.2 |
| 9 | −6279.728 | (variable) | | |
| 10 | 68.044 | 1.50 | 1.61340 | 44.3 |
| 11 | 39.028 | (variable) | | |
| 12 (stop) | ∞ | 1.35 | | |
| 13 | 57.301 | 6.26 | 1.76385 | 48.5 |
| 14 | −28.945 | 1.10 | 1.72047 | 34.7 |
| 15 | 78.466 | (variable) | | |
| 16 | −38.636 | 4.09 | 1.49700 | 81.5 |
| 17 | −17.611 | 1.00 | 1.77047 | 29.7 |
| 18 | −124.360 | 2.87 | | |
| 19 | 44.078 | 8.67 | 1.49700 | 81.5 |
| 20 | −36.107 | 0.20 | | |
| 21* | 97.208 | 5.16 | 1.80400 | 46.5 |
| 22* | −108.884 | (variable) | | |
| 23 | −1166.557 | 6.00 | 1.91650 | 31.6 |
| 24 | −38.579 | 1.74 | 1.59551 | 39.2 |
| 25 | 63.518 | (variable) | | |
| 26 | −144.259 | 1.20 | 1.54072 | 47.2 |
| 27 | 38.210 | 4.61 | 1.90366 | 31.3 |
| 28 | 99.227 | 10.97 | | |
| 29 | ∞ | 1.00 | 1.51633 | 64.1 |
| 30 | ∞ | 1.00 | | |
| Image Plane | ∞ | | | |

### Aspheric Surface Data

### 2nd Surface

$$K = 0. e + 00 A 4 = 5.82869 e - 08 A 6 = 3.28093 e - 10 A 8 = - 7.30293 e - 12 A 10 = 1.7347 e - 14$$

### 21st Surface

$$K = 0. e + 00 A 4 = 2.29294 e - 06 A 6 = - 2.9846 e - 09 A 8 = 1.20199 e - 10 A 10 = - 4.29392 e - 13 A 12 = 2.82932 e - 16$$

### 22nd Surface

$$K = 0. e + 00 A 4 = 1.40841 e - 05 A 6 = - 8.55175 e - 09 A 8 = 1.99012 e - 10 A 10 = - 6.29223 e - 13 A 12 = 4.48042 e - 16$$

### Various Data

Focal Length 27.52
F-Number 1.46
Angle of View 34.12
Overall Length of Lenses 121.21
BF 12.63

Lateral Magnification of Entire System
0.00 (INF) -0.025 -0.10 -0.20

| | | | | |
|---|---|---|---|---|
| d 9 | 2.24 | 3.04 | 5.66 | 9.65 |
| d11 | 12.92 | 12.12 | 9.49 | 5.50 |
| d15 | 8.23 | 7.60 | 5.84 | 3.70 |
| d22 | 1.20 | 1.46 | 2.82 | 5.73 |
| d25 | 3.98 | 4.34 | 4.74 | 3.98 |

### Lens Unit Data

| Unit | Start Surface | Focal Length | Lens Structure Length |
|---|---|---|---|
| L1 | 1 | 46.28 | 34.28 |
| L2 | 10 | −152.19 | 1.50 |
| L3 | 12 | 164.00 | 8.71 |
| L4 | 16 | 41.15 | 21.98 |
| L5 | 23 | −566.31 | 7.74 |
| L6 | 26 | −309.77 | 17.77 |

### Sixth Numerical Example

### Unit of Measure mm

| Surface Number | r | d | nd | vd |
|---|---|---|---|---|
| 1 | 364.760 | 1.30 | 1.59349 | 67.0 |
| 2* | 26.392 | 13.61 | | |
| 3 | −26.967 | 1.20 | 1.51633 | 64.1 |
| 4 | 535.718 | 1.59 | | |
| 5 | −2988.087 | 10.39 | 1.76385 | 48.5 |
| 6 | −24.893 | 1.30 | 1.85478 | 24.8 |
| 7 | −37.779 | 0.20 | | |
| 8 | 44.621 | 4.86 | 1.91082 | 35.2 |
| 9 | −2618.689 | (variable) | | |
| 10 | 75.335 | 1.50 | 1.61340 | 44.3 |
| 11 | 39.000 | (variable) | | |
| 12 (stop) | ∞ | 1.25 | | |
| 13 | 47.897 | 6.20 | 1.76385 | 48.5 |
| 14 | −34.180 | 1.10 | 1.72047 | 34.7 |
| 15 | 65.262 | (variable) | | |
| 16 | −37.971 | 4.08 | 1.49700 | 81.5 |
| 17 | −17.944 | 1.00 | 1.77047 | 29.7 |
| 18 | −142.210 | 2.80 | | |
| 19 | 47.678 | 8.51 | 1.49700 | 81.5 |
| 20 | −34.054 | 0.20 | | |
| 21* | 102.030 | 5.06 | 1.80400 | 46.5 |
| 22* | −107.005 | (variable) | | |
| 23 | −528.497 | 6.00 | 1.91650 | 31.6 |
| 24 | −37.503 | 1.71 | 1.59551 | 39.2 |
| 25 | 59.447 | (variable) | | |
| 26 | −63.467 | 1.20 | 1.54072 | 47.2 |
| 27 | 39.740 | 6.66 | 1.90043 | 37.4 |
| 28 | −578.466 | 10.97 | | |
| 29 | ∞ | 1.00 | 1.51633 | 64.1 |
| 30 | ∞ | 1.00 | | |
| Image Plane | ∞ | | | |

### Aspheric Surface Data

### 2nd Surface

$$K = 0. e + 00 A 4 = - 2.77516 e - 07 A 6 = - 1.54577 e - 09 A 8 = 6.44179 e - 13 A 10 = 7.64354 e - 16$$

### 21 st Surface

$$K = 0. e + 00 A 4 = 1.8012 e - 06 A 6 = - 4.51707 e - 09 A 8 = 9.41454 e - 11 A 10 = - 3.12742 e - 13 A 12 = 1.29042 e - 16$$

### 22nd Surface

$$K = 0. e + 00 A 4 = 1.25047 e - 05 A 6 = - 9.09304 e - 09 A 8 = 1.59275 e - 10 A 10 = - 4.78303 e - 13 A 12 = 2.76852 e - 16$$

### Various Data

Focal Length 27.55
F-Number 1.46
Angle of View 34.09
Overall Length of Lenses 125.79
BF 12.63

Lateral Magnification of Entire System 0.00
(INF) −0.025 −0.10 −0.21

| | | | | |
|---|---|---|---|---|
| d 9 | 3.59 | 4.34 | 6.76 | 10.71 |
| d11 | 12.62 | 11.87 | 9.45 | 5.50 |
| d15 | 8.73 | 8.04 | 6.20 | 3.88 |
| d22 | 1.20 | 1.46 | 2.85 | 6.05 |
| d25 | 5.30 | 5.73 | 6.18 | 5.30 |

### Lens Unit Data

| Unit | Start Surface | Focal Length | Lens Structure Length |
|---|---|---|---|
| L1 | 1 | 47.69 | 34.45 |
| L2 | 10 | −133.93 | 1.50 |
| L3 | 12 | 146.07 | 8.55 |
| L4 | 16 | 42.39 | 21.65 |
| L5 | 23 | −319.83 | 7.71 |
| L6 | 26 | 463.88 | 19.83 |

### Seventh Numerical Example

### Unit of Measure mm

| Surface Number l | r | d | nd | vd |
|---|---|---|---|---|
| 1 | 599.457 | 1.30 | 1.59349 | 67.0 |
| 2* | 28.774 | 12.78 | | |
| 3 | −27.081 | 1.20 | 1.51633 | 64.1 |
| 4 | 219.970 | 1.75 | | |
| 5 | 803.402 | 10.37 | 1.76385 | 48.5 |
| 6 | −24.961 | 1.30 | 1.85478 | 24.8 |
| 7 | −37.785 | 0.20 | | |
| 8 | 45.294 | 5.02 | 1.91082 | 35.2 |
| 9 | −1051.130 | (variable) | | |
| 10 | 91.363 | 1.50 | 1.61340 | 44.3 |
| 11 | 39.018 | (variable) | | |
| 12 (stop) | ∞ | 1.26 | | |
| 13 | 46.494 | 6.38 | 1.76385 | 48.5 |
| 14 | −34.876 | 1.10 | 1.72047 | 34.7 |
| 15 | 63.458 | (variable) | | |
| 16 | −35.902 | 4.00 | 1.49700 | 81.5 |
| 17 | −18.127 | 1.00 | 1.77047 | 29.7 |
| 18 | −175.857 | 2.00 | | |
| 19 | 48.068 | 9.65 | 1.49700 | 81.5 |
| 20 | −33.486 | 0.20 | | |
| 21* | 95.577 | 5.66 | 1.80400 | 46.5 |
| 22* | −101.180 | (variable) | | |
| 23 | −290.592 | 6.00 | 1.91650 | 31.6 |
| 24 | −37.181 | 1.25 | 1.59551 | 39.2 |
| 25 | 63.256 | 5.00 | | |
| 26 | −67.855 | 1.20 | 1.54072 | 47.2 |
| 27 | 35.261 | 7.56 | 1.90043 | 37.4 |
| 28 | −578.466 | 10.97 | | |
| 29 | ∞ | 1.00 | 1.51633 | 64.1 |
| 30 | ∞ | 2.23 | | |
| Image Plane | ∞ | | | |

### Aspheric Surface Data

### 2nd Surface

$$K = 0. e + 00 A 4 = 3.61761 e - 07 A 6 = - 6.66364 e - 10 A 8 = 3.81905 e - 12 A 10 = - 2.19217 e - 15$$

### 21 st Surface

$$K = 0. e + 00 A 4 = 2.67559 e - 06 A 6 = - 2.9373 e - 09 A 8 = 6.58324 e - 11 A 10 = - 1.79203 e - 13 A 12 = - 8.74999 e - 18$$

### 22nd Surface

$$K = 0. e + 00 A 4 = 1.30939 e - 05 A 6 = - 7.05155 e - 09 A 8 = 1.25332 e - 10 A 10 = - 3.09303 e - 13 A 12 = 8.07445 e - 17$$

### Various Data

Focal Length 28.79
F-Number 1.46
Angle of View 32.90
Overall Length of Lenses 128.09
BF 13.86

Lateral Magnification of Entire System 0.00
(INF) −0.026 −0.10 −0.22

| | | | | |
|---|---|---|---|---|
| d 9 | 4.21 | 5.00 | 7.13 | 10.41 |
| d11 | 11.70 | 10.91 | 8.78 | 5.50 |
| d15 | 9.43 | 8.80 | 7.01 | 3.99 |
| d22 | 1.20 | 1.83 | 3.62 | 6.63 |

### Lens Unit Data

| Unit | Start Surface | Focal Length | Lens Structure Length |
|---|---|---|---|
| L1 | 1 | 46.32 | 33.93 |
| L2 | 10 | −112.24 | 1.50 |
| L3 | 12 | 141.88 | 8.75 |
| L4 | 16 | 42.91 | 22.51 |
| L5 | 23 | 9800.00 | 32.98 |

Table 1 shows various values of each numerical example.

TABLE 1

| | First | Second | Third | Fourth | Fifth | Sixth | Seventh |
|---|---|---|---|---|---|---|---|
| | Numerical | Numerical | Numerical | Numerical | Numerical | Numerical | Numerical |
| | Example | Example | Example | Example | Example | Example | Example |
| f2/f | −6.31 | −4.34 | −6.79 | −8.50 | −5.53 | −4.86 | −3.90 |
| M2/M4 | −1.90 | −1.21 | −1.28 | −2.60 | −1.43 | −1.25 | −1.21 |
| f2/f4 | −4.60 | −3.52 | −5.30 | −6.86 | −3.70 | −3.16 | −2.62 |
| \|f1/f2\| | 0.33 | 0.30 | 0.23 | 0.44 | 0.30 | 0.36 | 0.41 |
| \|fR/f\| | 2.85 | 2.50 | 2.93 | 2.46 | 11.26 | 16.84 | 340.35 |
| BF/f | 0.75 | 0.51 | 0.47 | 1.03 | 0.46 | 0.46 | 0.48 |
| Da/TL | 0.58 | 0.61 | 0.59 | 0.62 | 0.58 | 0.58 | 0.60 |
| D4/Da | 0.23 | 0.26 | 0.25 | 0.23 | 0.24 | 0.23 | 0.24 |
| (1 − β4²) × | 1.30 | 1.02 | 1.12 | 2.11 | 0.81 | 0.80 | 0.80 |
| βR² | | | | | | | |
| v4p | 81.54 | 81.54 | 81.54 | 81.54 | 81.54 | 81.54 | 81.54 |

### Imaging Apparatus

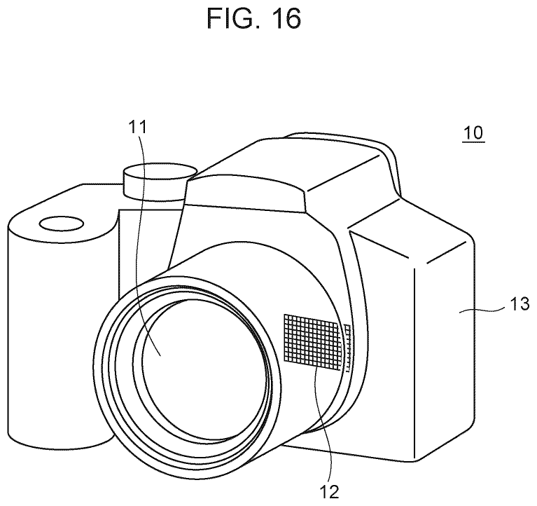

An embodiment of a digital still camera (imaging apparatus) including an optical system according to the present invention as an imaging optical system will be described with reference to FIG. 16. Referring to FIG. 16, an imaging optical system 11 is composed of an optical system according to any one of the first to seventh embodiments. An imaging device (photoelectric transducer) 12, such as a CCD sensor or a CMOS sensor, is disposed in a camera body 10. The imaging device 12 receives an optical image formed by the imaging optical system 11 and performs photoelectric conversion on the optical image. The camera body 10 may be a single-lens reflex camera including a quick return mirror or a mirrorless camera including no quick return mirror.

Thus, when the optical system L0 according to the present invention is applied to an imaging apparatus, such as a digital still camera, a high-resolution image with a wide angle of view can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-118058 filed Jul. 20, 2023, which is hereby incorporated by reference herein in its entirety.

What is claimed is:

1. An optical system comprising:
a first lens unit, a second lens unit having a negative refractive power, a third lens unit, and a fourth lens unit having a positive refractive power arranged in that order from an object side to an image side,
wherein intervals between adjacent ones of the lens units change during focusing,
wherein the second lens unit moves toward the image side and the fourth lens unit moves toward the object side during focusing from infinity to close range, and
wherein the following inequality is satisfied:
$$- 10. < f 2 / f < - 3.6$$
where f2 is a focal length of the second lens unit and f is a focal length of an entire system.

2. The optical system according to claim 1, wherein the following inequality is satisfied:
$$- 3.5 < M 2 / M 4 < - 0.5$$
where M2 and M4 are respectively an amount of movement of the second lens unit and an amount of movement of the fourth lens unit during focusing from infinity to an object distance at which a lateral magnification of the entire system is −0.1, and a sign of an amount of movement toward the image side is positive.

3. The optical system according to claim 1, wherein the following inequality is satisfied:
$$- 7. < f 2 / f 4 < - 2.5$$
where f4 is a focal length of the fourth lens unit.

4. The optical system according to claim 1, wherein the following inequality is satisfied:
$$0.05 < \vert f 1 / f 2 \vert < 0.5$$
where f1 is a focal length of the first lens unit.

5. The optical system according to claim 1, wherein the following inequality is satisfied:
$$2. < \vert fR / f \vert < 500.$$
where fR is a focal length of one of the lens units that is closest to the image side in the optical system.

6. The optical system according to claim 1, wherein the following inequality is satisfied:
$$0.3 < BF / f < 1.5$$
where BF is a back focal length when the optical system is focused at infinity.

7. The optical system according to claim 1, further comprising:
an aperture stop,
wherein the following inequality is satisfied:
$$0.45 < Da / TL < 0.7$$
where Da is a distance from the aperture stop to an image plane along an optical axis when the optical system is focused at infinity and TL is an overall lens length of the optical system.

8. The optical system according to claim 7, wherein the aperture stop is closer to the image side than a surface of the second lens unit that is closest to the image side.

9. The optical system according to claim 7, wherein the following inequality is satisfied:
$$0.15 < D 4 / Da < 0.35$$
where D4 is a distance from the aperture stop to a surface of the fourth lens unit that is closest to the object side along the optical axis.

10. The optical system according to claim 1, wherein the following inequality is satisfied:
$$0.7 < ( 1 - {β4}^{2} ) \times β {R}^{2} < 3.$$
where β4 is a lateral magnification of the fourth lens unit and βR is a combined lateral magnification of all of the lens units disposed closer to the image side than the fourth lens unit when the optical system is focused at infinity.

11. The optical system according to claim 1, wherein the following inequality is satisfied:
$$70. < v 4 p < 96.$$
where ν4p is an Abbe number of at least one positive lens included in the fourth lens unit.

12. The optical system according to claim 1, wherein an entirety or part of a lens element included in the third lens unit moves in a direction including a component perpendicular to an optical axis during image blur correction.

13. The optical system according to claim 1, wherein the optical system includes the first lens unit having a positive refractive power, the second lens unit, the third lens unit having a positive refractive power, the fourth lens unit, and a fifth lens unit having a negative refractive power arranged in that order from the object side to the image side.

14. The optical system according to claim 1, wherein the optical system includes the first lens unit having a negative refractive power, the second lens unit, the third lens unit having a positive refractive power, the fourth lens unit, and a fifth lens unit having a negative refractive power arranged in that order from the object side to the image side.

15. The optical system according to claim 1, wherein the optical system includes the first lens unit having a positive refractive power, the second lens unit, the third lens unit having a positive refractive power, the fourth lens unit, a fifth lens unit having a negative refractive power, and a sixth lens unit having a negative refractive power arranged in that order from the object side to the image side.

16. The optical system according to claim 1, wherein the optical system includes the first lens unit having a positive refractive power, the second lens unit, the third lens unit having a positive refractive power, the fourth lens unit, a fifth lens unit having a negative refractive power, and a sixth lens unit having a positive refractive power arranged in that order from the object side to the image side.

17. The optical system according to claim 1, wherein the optical system includes the first lens unit having a positive refractive power, the second lens unit, the third lens unit having a positive refractive power, the fourth lens unit, and a fifth lens unit having a positive refractive power arranged in that order from the object side to the image side.

18. An optical system comprising:
a first lens unit, a second lens unit having a negative refractive power, a third lens unit, and a fourth lens unit having a positive refractive power arranged in that order from an object side to an image side,
wherein intervals between adjacent ones of the lens units change during focusing,
wherein the second lens unit moves toward the image side and the fourth lens unit moves toward the object side during focusing from infinity to close range, and
wherein the first lens unit includes a negative meniscus lens and a positive lens, the negative meniscus lens having a convex surface facing the object side.

19. An imaging apparatus comprising:
an optical system; and
an imaging device configured to receive an image formed by the optical system,
wherein the optical system includes a first lens unit, a second lens unit having a negative refractive power, a third lens unit, and a fourth lens unit having a positive refractive power arranged in that order from an object side to an image side,
wherein intervals between adjacent ones of the lens units change during focusing,
wherein the second lens unit moves toward the image side and the fourth lens unit moves toward the object side during focusing from infinity to close range, and
wherein the following inequality is satisfied:
$$- 10. < f 2 / f < - 3.6$$
where f2 is a focal length of the second lens unit and f is a focal length of an entire system.
